(19) United States
(12) Patent Application Publication
(10) Pub. No.: US 2007/0213996 A1
(43) Pub. Date: Sep. 13, 2007

(54) Know-How Service System

(75) Inventors: Toshiro Tomita, Tokyo (JP); Tetsuo Hoshi, Tokyo (JP); Koji Demachi, Tokyo (JP); Toshiki Ogawa, Tokyo (JP); Yoji Saito, Tokyo (JP); Hirofumi Takahashi, Tokyo (JP)

Correspondence Address: EDWARDS ANGELL PALMER & DODGE LLP, P.O. BOX 55874, BOSTON, MA, 02205, US

(73) Assignee: Yokogawa Electric Corporation, Tokyo (JP)

(21) Appl. No.: 11/587,686

(22) PCT Filed: Apr. 26, 2005
(86) PCT No.: PCT/JP05/08376

§ 371 Date: Oct. 25, 2006

(30) Foreign Application Priority Data
Apr. 27, 2004 (JP) 2004-131117

(51) Int. Cl. G06F 19/00; G06Q 10/00

(52) U.S. Cl. 705/1

(57) ABSTRACT

A know-how service system capable of handling integrally a life cycle management extended from installment to operation, maintenance, and scrapping of various equipments in a facility such as a plant, a factory, a hospital, a school, a vessel, or the like by utilizing a know-how scattered and held individually via a network, includes a know-how service providing portion, a know-how service utilizing portion, a know-how service applying portion, and a network to which respective portions are connected.

### BACKGROUND OF THE INVENTION

1. Technical Field

The present invention relates to a know-how service system and, more particularly, a know-how service system capable of handling integrally a life cycle management extended from installment to operation, maintenance, and scrapping of various equipments in the facility such as plant, factory, hospital, or the like, which carries out works by utilizing a wide variety of equipments supplied from a plurality of vendors, by utilizing know-how provided from the vendor, the user, the maintenance service company, and the like.

2. Background Art

In JP-A-2002-7518, the configuration of the service system using the network is disclosed.

FIG. 7 is a conceptual configurative view of the service system for use in the plant disclosed in JP-A-2002-7518. In FIG. 7, a plant 10 includes control equipments of a plurality of vendors. In an example of FIG. 7, the plant 10 functions as a predetermined plant when an A-company control equipment 11, a B-company control equipment 12, a C-company control equipment 13, and a D-company control equipment 14 cooperate with each other. Here, the control equipments 11 to 14 contain the distributed control system (DCS), the analytical instrument, and the like.

Remote control computers 31 to 34 of vendor companies A to D and a transit computer 40 are connected to a network 20. The transit computer 40 is connected to the plant 10 via a line 50 such as a dedicated line, for example. The transit computer 40 accepts collectively the access requests issued from the remote control computers 31 to 34 of the vendor companies A to D, and then send out the requests to the plant 10. Then, the remote control computers 31 to 34 of the vendor companies A to D get the access to the plant 10 via the transit computer 40, and then provide the service containing operation monitoring, equipment management, and equipment check to the control equipments 11 to 14 manufactured by their own companies provided to the plant 10.

A software storing portion 60 stores softwares used when the vendor companies A to D provide the service respectively. In the example in FIG. 7, the softwares used to provide the service to the control equipments 11 to 14 are stored. In this case, the software storing portion 60 may be provided in the transit computer 40.

The transit computer 40 has a storing portion 41, a memory 42, a distributing portion 43, and a charging portion 44.

The storing portion 41 installs the software, which is used by the vendor of the remote control computer that has the access, into the memory 42 of the transit computer 40 when the remote control computers 31 to 34 of the vendor companies A to D get the access to the transit computer 40.

The distributing portion 43 distributes the software installed into the memory 42 to the plant 10 and the remote control computer. The software distributed to the plant 10 provides the service to the control equipment as the object. A monitor screen is displayed on the remote control computer when the software distributed to the remote control computer is executed.

The charging portion 44 charges a fee for service to the remote control computers 31 to 34 of the vendor companies A to D. The charge is as a use fee of the infrastructure that the transit computer 40 provides or a use fee of the application program that resides in the transit computer 40, for example. As the charging system executed by the charging portion 44, for example, the flat-rate charging system in which a fixed-amount fee is charged every predetermined period or the measured-rate charging system in which the charge is made according to an amount of traffic in a predetermined period is employed.

A personal computer 15 is provided to the plant 10. This personal computer 15 has a storing portion 16, an executing portion 17, and an erasing portion 18. The storing portion 16 stores the software that is distributed to the plant 10 by the distributing portion 43. The executing portion 17 executes the software stored in the storing portion 16 to provide the service to the control equipments 11 to 14. The erasing portion 18 erases the software distributed by the distributing portion 43 when operations of the remote control computers 31 to 34 are ended. When the softwares of respective equipments of the vendor companies A to D always reside in the plant 10, the personal computer 15 must run respective softwares according to a multitask system. In this case, a burden put on the personal computer 15 is increased and thus a response to the access is delayed. Therefore, in the service system in FIG. 7, the burden put on the personal computer 15 is reduced by supplying the necessary software to the personal computer 15 when such software is needed, and erasing the software when the work is ended.

However, following problems exist in the foregoing service system.

In the service system in FIG. 7, the control equipments 11 to 14 of the vendor companies A to D set up in the plant site can be operated and monitored from a remote place by using the remote control computers 31 to 34.

In this event, the plant 10 functions as the predetermined plant when the control equipments 11 to 14 of the vendor companies A to D, which are different in type respectively, act in cooperation with each other. Therefore, in order to carry out smoothly and effectively the operation and the maintenance of the overall plant 10, the engineers who have experience in operation and maintaining the overall plant 10 built up by the control equipments 11 to 14 of the vendor companies A to D or the engineers who are engaged in operation and maintenance of the plant 10 in the company that possesses the plant 10 must use positively their own know-hows.

Also, it is possible for the engineer, who is engaged in operation and maintenance of the plant 10 in the company that possesses the plant 10, to execute the operation and maintenance of sensors, controllers, control systems, and the like used in controlling and monitoring the plant 10. However, in order to diagnose the facilities such as pumps, boilers, and the like as the particular controlled objects, the know-hows regarding these equipments in the vendor companies A to D are indispensable. Thus, it is difficult for the engineers, who belong to the companies except the concerned vendors, to conduct these diagnoses exactly.

Also, the program used in operating and maintaining the plant runs only on the particular platform. Therefore, the general-purpose platform such as the management personal computer 15 shown in FIG. 7 must be interposed.

In addition, the charging system in the service system shown in FIG. 7 depends upon the communication time or the communication charges. Therefore, such a problem lies that only the same charging system as that applied to the simple operation can be applied to the operation and the diagnosis containing high-level know-hows.

### SUMMARY OF THE INVENTION

An object of the present invention is to provide a know-how service system capable of handling integrally a life cycle management extended from installment to operation, maintenance, and scrapping of various equipments in a facility such as a plant, a factory, a hospital, a school, a vessel, or the like by utilizing the know-how scattered and held individually via the network.

The present invention provides a know-how service system, which includes a know-how service providing portion; a know-how service utilizing portion; a know-how service applying portion; and a network to which the know-how service providing portion, the know-how service utilizing portion, and the know-how service applying portion are connected.

In the know-how service system, the know-how service providing portion includes

a know-how describing portion which describes a know-how to be provided, in XML, and

a know-how encrypting portion which encrypts the know-how described in XML.

In the know-how service system, the know-how service providing portion installs a know-how into an agent to provide the know-how.

In the know-how service system, the know-how service providing portion hierarchizes a know-how to be provided, according to a hierarchical structure of the know-how service applying portion.

In the know-how service system, the know-how service providing portion makes a predetermined charge according to a hierarchy of a know-how service that the know-how service utilizing portion utilizes.

In the know-how service system, an object to which a know-how service is provided is a facility that is built up by equipments supplied from a plurality of vendors.

In the know-how service system, the facility is at least one of a plant, a factory, a hospital, a school, and a vessel.

In the know-how service system, the know-how service applying portion executes processes as to a know-how service based on a self-diagnosis result.

In the know-how service system, the know-how service is a service regarding a life cycle management extended from installment to operation, maintenance, and scrapping of an equipment.

According to the know-how service system, the environment in which the operating situation/abnormality sensing and the preventive maintenance service of various equipments can be carried out effectively can be provided. Also, the service offered based on the know-how that respective companies possess can be provided via the Internet in a chargeable mode and also utilized.

A particular service with a high degree of specialization can be realized in cooperation with a plurality of know-how possessors.

The operating environment of these know-how services is not limited to the particular platform. These know-how services can be utilized in the open environment.

A distribution of the know-how can be attained safely without fail by disclosing a know-how describing method, a hiding encrypting method, an access method, and the like.

Then, the service of carrying out the diagnosis, the operation, etc. of measuring/controlling equipments and also the facility can be utilized not to disclose the know-how to an unspecified large number of people.

### BRIEF DESCRIPTION OF THE DRAWINGS

FIG. 1 is a configurative view showing an embodiment of a know-how service system according to the present invention;

FIG. 2 is a block diagram showing a configurative example of know-how providing servers;

FIG. 3 is a block diagram showing a configurative example of a know-how managing server;

FIG. 4 is a block diagram showing a configurative example of control equipments constituting plants;

FIG. 5 is a conceptual view showing descriptions of a service know-how;

FIG. 6 is a hierarchical explanatory view showing a concept of a diagnosis agent; and

FIG. 7 is a conceptual view showing the related service system using the network.

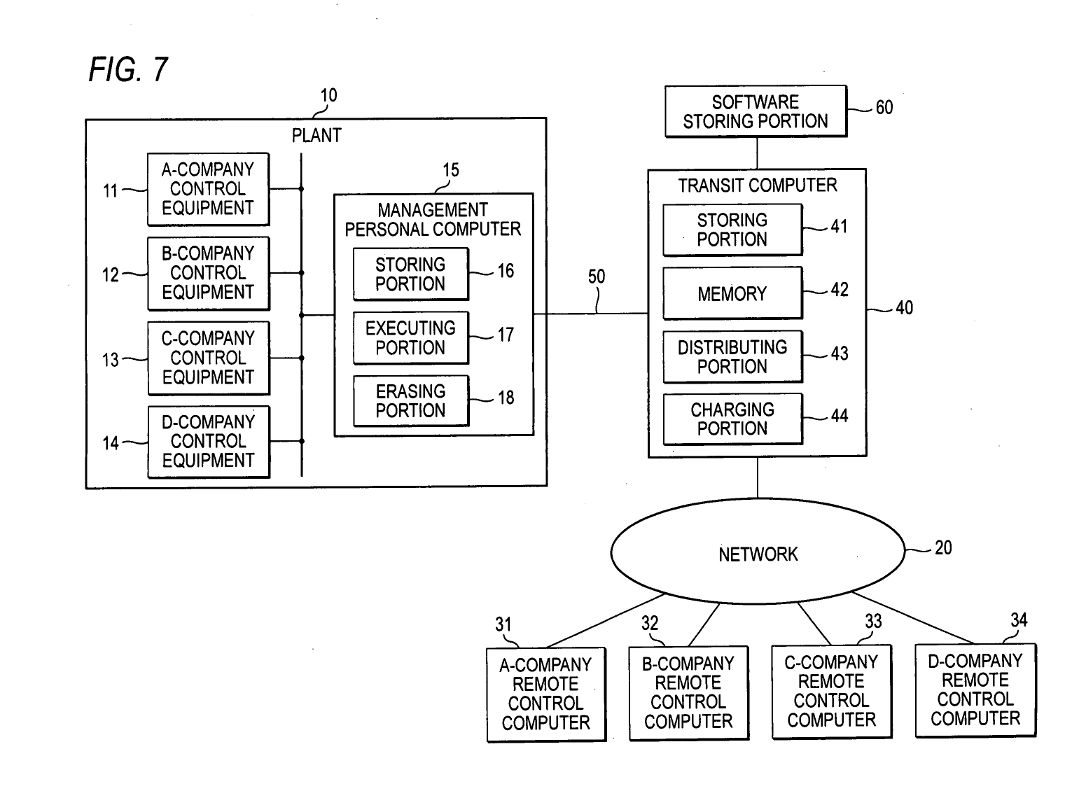

### DETAILED DESCRIPTION OF THE PREFERRED EMBODIMENTS

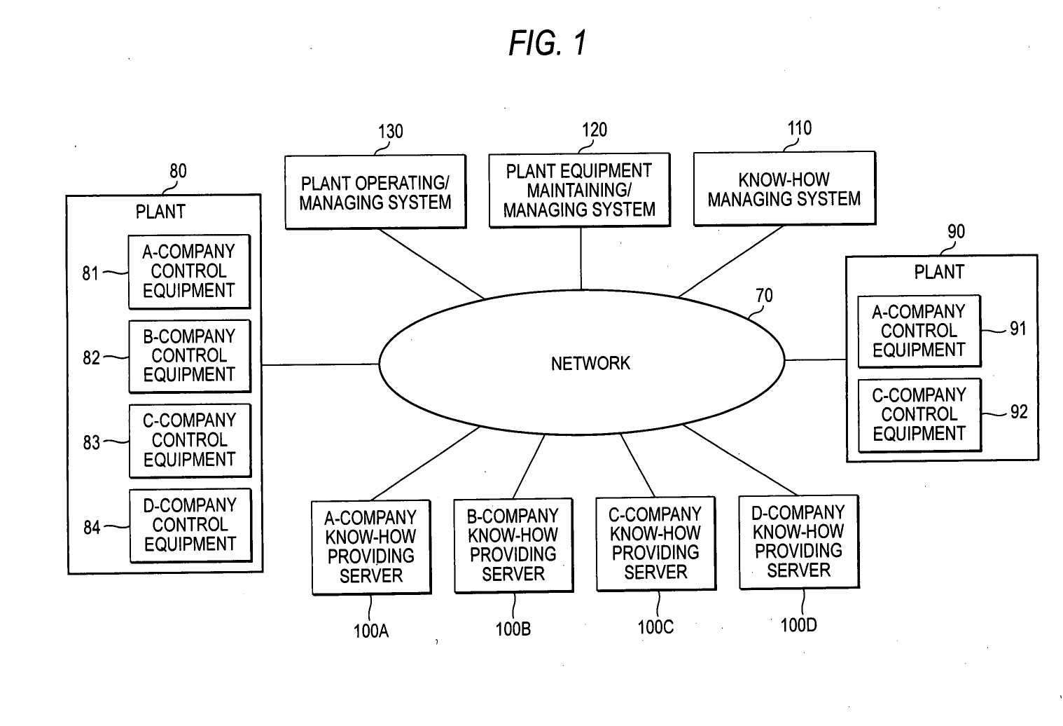

An embodiment of a know-how service system according to the present invention will be explained in detail with reference to the drawings hereinafter. FIG. 1 is a configurative view showing an embodiment of a know-how service system according to the present invention. A network 70 is the Internet, for example. A plant 80 and a plant 90 having control equipments of a plurality of vendors respectively are connected to this network 70. Here, the plant 80 has an A-company control equipment 81, a B-company control equipment 82, a C-company control equipment 83, and a D-company control equipment 84, and also the plant 90 has an A-company control equipment 91 and a C-company control equipment 92, for example. These control equipments contain the sensor, the controller, the pump and the boiler controlled by the controller, and the like.

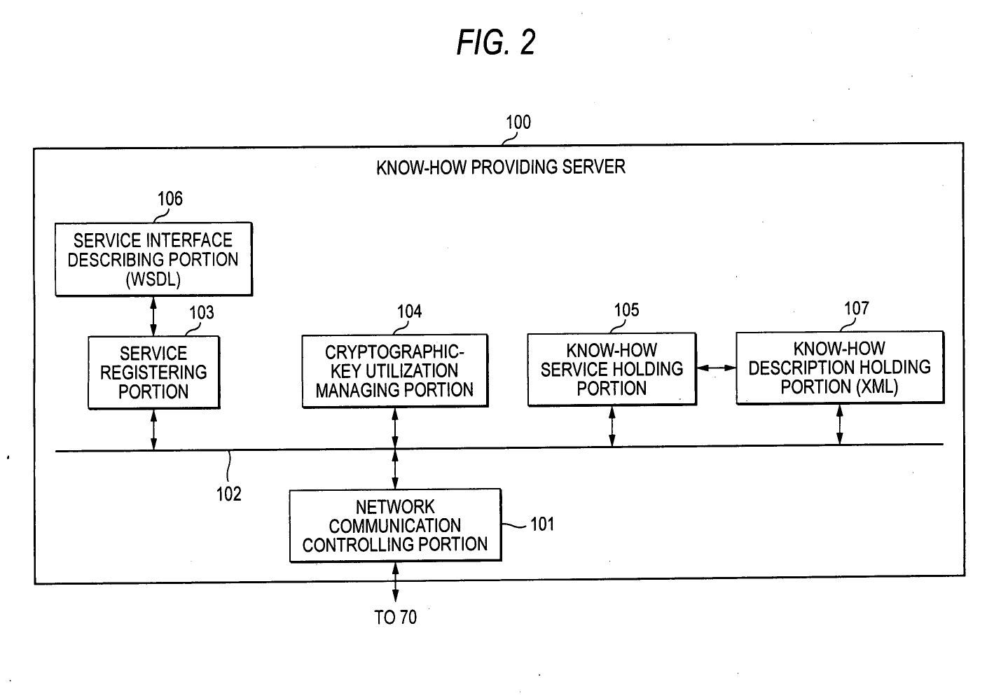

Also, know-how providing servers 100A to 100D of respective companies to provide the know-hows of the vendor companies A to D are connected to the network 70. FIG. 2 is a block diagram showing a configurative example of these know-how providing servers 100A to 100D. Each of the know-how providing servers 100A to 100D has a network communication controlling portion 101, an internal bus 102, a service registering portion 103, a cryptographic-key utilization managing portion 104, a know-how service holding portion 105, a service interface describing portion 106, and a know-how description holding portion 107.

In FIG. 2, the network communication controlling portion 101 functions as an interface to connect the network 70 and the internal bus 102 of the know-how providing server 100. The service registering portion 103, the cryptographic-key utilization managing portion 104, and the know-how service holding portion 105 are connected to the internal bus 102. The service interface describing portion 106 is connected to the service registering portion 103. The know-how description holding portion 107 is connected to the know-how service holding portion 105.

In case the know-how is described in XML, it is possible that a third person knows the contents of the know-how because this XML is described by the character string. Therefore, the know-how provider encrypts the know-how by using the cryptographic-key utilization managing portion 104 of the know-how providing server 100, and then entrusts a know-how managing server 110 with the management of the cryptographic key.

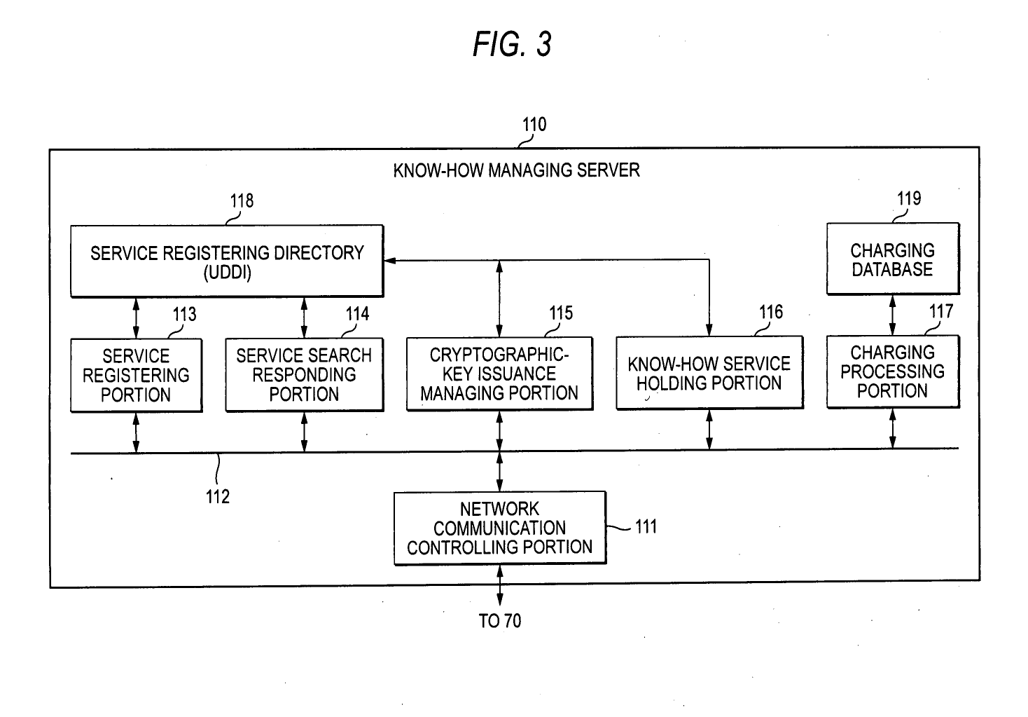

In FIG. 1, the know-how managing server 110 for managing collectively the know-hows provided from the know-how providing servers 100A to 100D of the vendor companies A to D is connected to the network 70. FIG. 3 is a block diagram showing a configurative example of the know-how managing server 110. The know-how managing server 110 has a network communication controlling portion 111, an internal bus 112, a service registering portion 113, a service search responding portion 114, a cryptographic-key issuance managing portion 115, a know-how service holding portion 116, a charging processing portion 117, a service registering directory 118, and a charging database 119.

In FIG. 3, the network communication controlling portion 111 functions as an interface to connect the network 70 and the internal bus 112 of the know-how managing server 110. The service registering portion 113, the service search responding portion 114, the cryptographic-key issuance managing portion 115, the know-how service holding portion 116, and the charging processing portion 117 are connected to the internal bus 112. The service registering directory 118 is connected to the service registering portion 113, the service search responding portion 114, the cryptographic-key issuance managing portion 115, and the know-how service holding portion 116. The charging database 119 is connected to the charging processing portion 117.

In FIG. 1, a plant equipment maintaining/managing system 120 of the service company that contacts for maintenance/management of the control equipments 81 to 84, 91 and 92 constituting the plants 80, 90, and a plant operating/managing system 130 that the department of the company that possesses the plants 80, 90 utilizes to manage the plant operating condition are connected to the network 70.

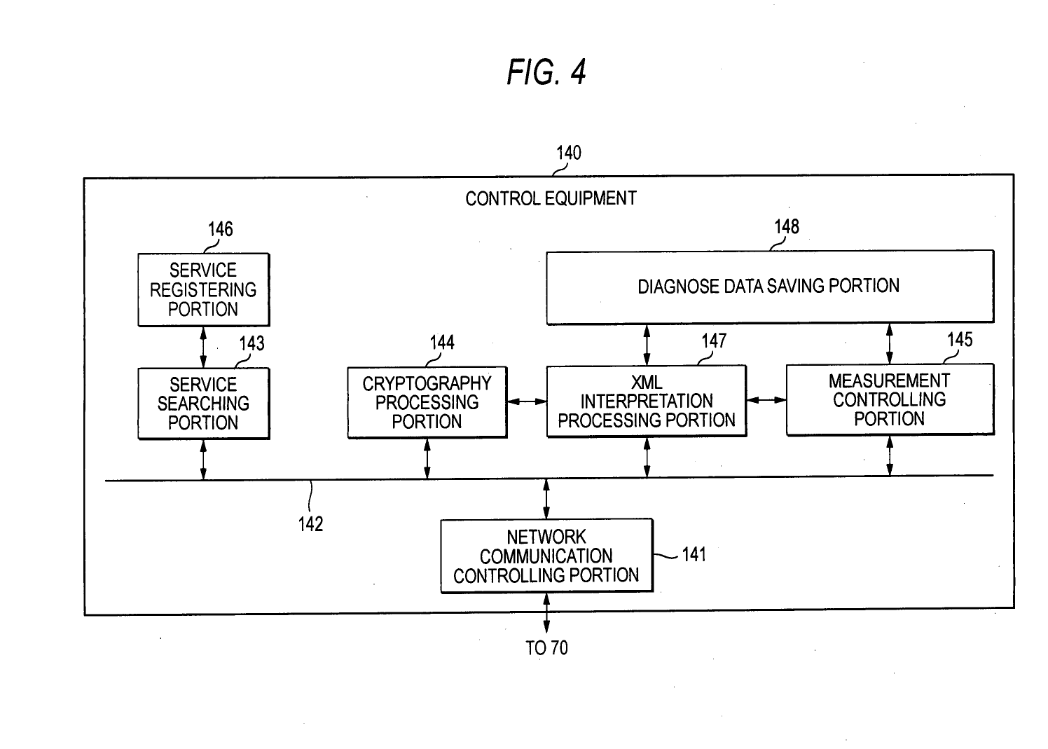

FIG. 4 is a block diagram showing a configurative example of control equipments 81 to 84, 91 and 92 constituting the plants 80, 90. In FIG. 4, explanation will be made by referring to the control equipments 81 to 84, 91 and 92 collectively as a control equipment 140. The control equipment 140 has a network communication controlling portion 141, an internal bus 142, a service searching portion 143, a cryptography processing portion 144, a measurement controlling portion 145, a service registering portion 146, an XML interpretation processing portion 147, and a diagnose data saving portion 148.

In FIG. 4, the network communication controlling portion 141 functions as an interface to connect the network 70 and the internal bus 142 of control equipment 140. The service searching portion 143, the cryptography processing portion 144, and the measurement controlling portion 145 are connected to the control equipment 140. The service registering portion 146 is connected to the service searching portion 143. The XML interpretation processing portion 147 is connected between the cryptography processing portion 144 and the measurement controlling portion 145. The diagnose data saving portion 148 is connected to the measurement controlling portion 145 and the XML interpretation processing portion 147.

An operation of the know-how service system in the present embodiment will be explained hereunder.

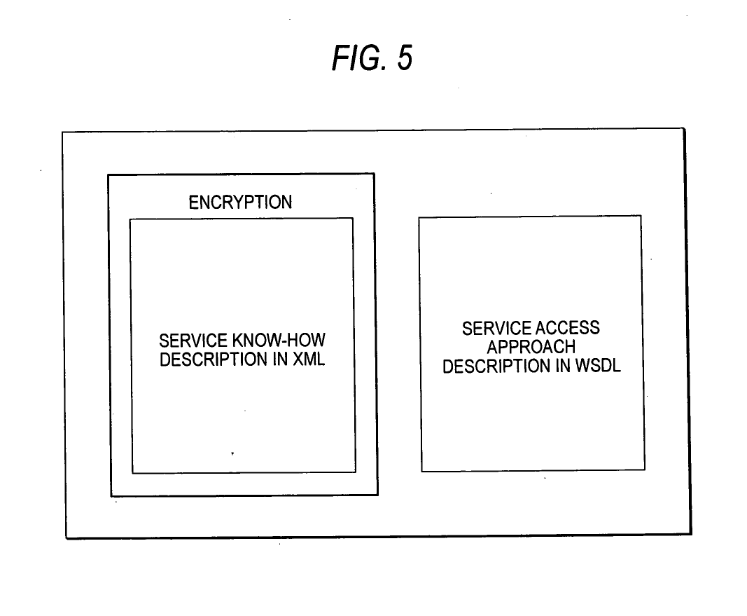

The know-how providers of the vendor companies A to D, who are the vendors of the control equipments 81 to 84, 91 and 92 constituting the plants 80, 90, describe the diagnosis know-how concerning the control equipments, e.g., the diagnosis know-how concerning a lifetime of the pump, in XML and also describe its service interface approach in WSDL (Web Service Description Language), as shown in FIG. 5. More particularly, the diagnosis know-how is described by the know-how description holding portion 107 of the know-how providing server 100 shown in FIG. 2 in XML, and also the service interface approach is described by the service interface describing portion 106 in WSDL.

Then, the know-how providers of respective vendors register the search information such as names, contents, store addresses, etc. of the know-how, which are described in XML, on the UDDI (Universal Description, Discovery, and Integration) service registering directory 118 of the know-how managing server 110 via the service registering portion 103 of the know-how providing server 100 and the service registering portion 113 of the know-how managing server 110 such that the user of the know-how can search the information as occasion demands. In this case, charging tables that are set individually according to the application range of the available know-how service are stored in the service registering directory 118. Here, the users of the know-how contain the service company that contracts for maintenance/management of the control equipments, which connects the plant equipment maintaining/managing system 120 to the network 70, the company that possesses the plant, which connects the plant operating/managing system 130 to the network 70, and the like.

Then, in order to provide the know-how described in XML as Web service, the know-how provider of the vendor stores the know-how described in XML in a predetermined storing destination described in WSDL, particularly the know-how service holding portion 105 of the know-how providing server 100 managed by vendor's self, the know-how service holding portion 116 of the external know-how managing server 110, or the like.

Here, the facility manager, that is registered in advance in the know-how managing server 110 as the user of the know-how and possesses the plant operating/managing system 130, utilizes the diagnosis know-how regarding a lifetime of the pump as the control equipment 140 in the plant. The facility manager searches the service registering directory 118 via the service search responding portion 114 of the know-how managing server 110, and then specifies the Web service relating to the diagnosis know-how about a lifetime of the pump from the registered service data. Then, the facility manager instructs the control equipment 140, which monitors and controls the pump as the diagnosed object, to execute the specified Web service.

The control equipment 140 when is instructed to execute the Web service has the access to the know-how registering server in which the designated Web service is registered, and then identifies the interface. Also, the control equipment 140 gets the access to the know-how managing server 110, and then acquires the cryptographic key peculiar to the know-how of the Web service designated by the cryptographic-key issuance managing portion 115. The cryptography processing portion 144 of the control equipment 140 translates the encrypted know-how into the XML-described statement based on the cryptographic key, and then inputs the statement into the XML interpretation processing portion 147. The XML interpretation processing portion 147 interprets the XML-described statement into the particular measurement controlling operation and then inputs the operation into the measurement controlling portion 145. The measurement controlling portion 145 executes the Web service to conduct the diagnosis actually. The contents of the interpretation in the XML interpretation processing portion 147 and the diagnosed result of the measurement controlling portion 145 are saved in the diagnose data saving portion 148, and also are sent out to the facility manager via the plant operating/managing system 130.

The know-how managing server 110 calculates a charged amount required to utilize the diagnosis know-how regarding a lifetime of the pump based on the charging table registered in the service registering directory 118, and then inputs charging data into the charging processing portion 117. The charging processing portion 117 executes the predetermined charging process every time when the Web service is used, transfers charging history data such as the used day and time and the user of the Web service, an application range of the service, a charged amount, etc. to the charging database 119, and stores the data in the charging database 119.

According to the know-how service system of the present embodiment, the user of the plant, the factory, or the like, for example, can introduce the optimum equipments independent of the particular vendor and also enjoy the diagnosis/operation service most suitable for these equipments via the network at need.

In contrast, the vendor or the maintenance service company can provide the running/operation/diagnosis service for the user of the plant, the factory, or the like via the network without disclosure of own company's know-how and also execute the proper charging process in answer to the contents of service or the treatment level.

Then, the network operator of such know-how service can provide the service that each service user needs, by gathering the information supplied from a plurality of know-how providers. Also, the network operator can perform a facilitator function to connect the know-how user and the know-how provider via charging of a fee to the service user, payment of a use fee to the know-how provider, etc. and thus accept an agency free in exchange for the service.

Here, in the above embodiment, the case where the diagnosis know-how concerning a lifetime of the pump is utilized by facility-manager's own will is explained. But the present invention is not limited to the above case. For example, a self-diagnosis function may be installed in advance into the control equipment 140 and then the control equipment 140 may be repaired automatically by utilizing the know-how service when an error occurs. In this case, addresses of the Web services that provide the know-how service to eliminate various errors whose occurrence is predicted is stored in the service registering portion 146 of the control equipment 140. When the control equipment 140 detects an occurrence of the error by a self-diagnosis function, the service searching portion 143 searches the address of the Web service from the service registering portion 146 to eliminate the error, and then carries out a predetermined know-how service. As the address of the Web service, there are an address of the know-how managing server 110, an address of the know-how providing server 100, an internal address that is self-completed by the control equipment 140 itself, and the like.

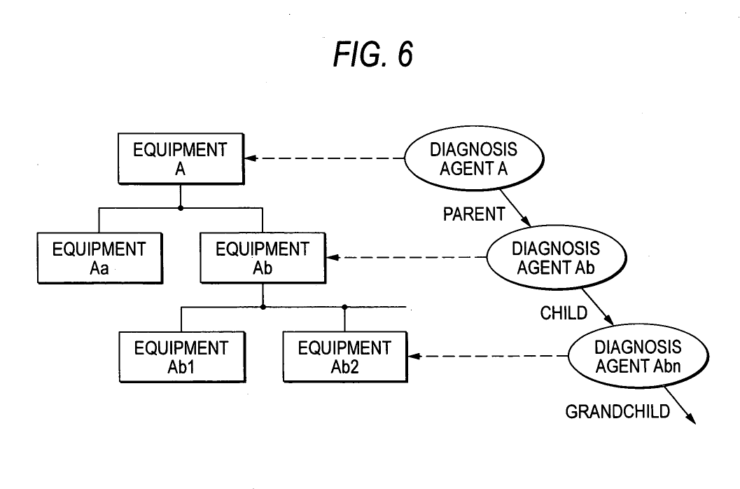

Also, in the above embodiment, the case where the know-how described in XML is provided as the Web service is explained. But the equivalent know-how incorporated in the agent can be provided. In case an object of service is a process control system, the agent may be built up by a hierarchical structure shown in FIG. 6 since the process control system is constructed by various equipments provided to constitute a hierarchical structure.

Also, in the above embodiment, the case where the diagnosis know-how concerning a lifetime of the pump in the plant is utilized is explained. But the present invention is not limited to the above case. Also, the know-how service system regarding a life cycle management extended from installment to operation, maintenance, and scrapping of various equipments in the facility such as the factory, the hospital, or the like other than the plant can be provided and executed in the similar way.

Also, in the above embodiment, an example in which a single know-how is utilized is explained. But a plurality of know-hows may be utilized in combination.

Also, the know-how provider is not limited to the vendor, and the user or the maintenance service company may provide the know-how.

What is claimed is:

1. A know-how service system, comprising:
a know-how service providing portion;
a know-how service utilizing portion;
a know-how service applying portion; and
a network to which the know-how service providing portion, the know-how service utilizing portion, and the know-how service applying portion are connected.

2. The know-how service system according to claim 1, wherein the know-how service providing portion includes:
a know-how describing portion which describes a know-how to be provided, in XML; and
a know-how encrypting portion which encrypts the know-how described in XML.

3. The know-how service system according to claim 1,
wherein the know-how service providing portion installs a know-how into an agent to provide the know-how.

4. The know-how service system according to claim 1,
wherein the know-how service providing portion hierarchizes a know-how to be provided, according to a hierarchical structure of the know-how service applying portion.

5. The know-how service system according to claim 1,
wherein the know-how service providing portion makes a predetermined charge according to a hierarchy of a know-how service that the know-how service utilizing portion utilizes.

6. The know-how service system according to claim 1,
wherein an object to which a know-how service is provided is a facility that is built up by equipments supplied from a plurality of vendors.

7. The know-how service system according to claim 6,
wherein the facility is at least one of a plant, a factory, a hospital, a school, and a vessel.

8. The know-how service system according to claim 1,
wherein the know-how service applying portion executes processes as to a know-how service based on a self-diagnosis result.

9. The know-how service system according to claim 1,
wherein the know-how service is a service regarding a life cycle management extended from installment to operation, maintenance, and scrapping of an equipment.
